(19) United States
(12) Patent Application Publication
(10) Pub. No.: US 2026/0225482 A1
(43) Pub. Date: Aug. 6, 2026

(54) MODULAR SMART FRAME SYSTEM

(71) Applicant: Chukwudi OKAFOR, London (GB)

(72) Inventor: Chukwudi Okafor, London (GB)

(21) Appl. No.: 19/149,900

(22) PCT Filed: Jan. 1, 2023
(86) PCT No.: PCT/GB2023/050187

§ 371 Date: Jul. 22, 2025

(51) Int. Cl. G06F 3/14; B60L 53/16; B60L 53/68; H01M 10/46; H01M 10/48; H01M 50/249; H01M 50/262; H02J 7/70

(52) U.S. Cl. CPC B60L 53/30; B60L 53/16; B60L 53/68; G06F 3/1446; H01M 10/46; H01M 10/488; H01M 50/249; G09G 2300/026; G09G 2380/10; H01M 2220/20; Y02T 10/7072; Y02T 90/10; Y02T 90/12

(57) ABSTRACT

The present disclosure provides a smart modular frame system which is configured with one or more connectable frame devices, each having at least one universal port for connecting to one of various types of functional modules. The functional modules include display devices which, when connected together in an arrangement of frame devices, can form a single display matrix with coherent imaging across their multiple display panels. The functional modules further comprise one or more charging bank modules with arrays of ports for charging various battery types according to manufacturer specifications. The modular frame systems are adaptable to their environment both in function and shape and can provide essential public services in co-ordination with a cloud network operating system.

### FIELD OF INVENTION

The present invention relates generally to modular systems. More specifically the present invention relates to a system of wall-mounted frames with universal ports for coupling to various functional modules.

### BACKGROUND

The modern individual relies increasingly on electronic devices of all types in daily life, and in highly populated environments such as cities it is important to have easy access to battery and vehicle charging ports at all times.

It is also important in such environments for information to be able to be displayed prominently in public spaces, both for informative purposes and advertising purposes. The use of video displays in cities is increasingly common.

A problem associated with both of these points is that the needs, both physical and commercial, of city environments are constantly shifting. An adaptable solution is required that can be installed in constrained spaces and which can be quickly adapted to changing functional requirements. It is within this context that the present invention is provided.

### SUMMARY

The present disclosure provides a smart modular frame system which is configured with one or more connectable frame devices, each having at least one universal port for connecting to one of various types of functional modules. The functional modules include display devices which, when connected together in an arrangement of frame devices, can form a single display matrix with coherent imaging across their multiple display panels. The functional modules further comprise one or more charging bank modules with arrays of ports for charging various battery types according to manufacturer specifications. The frame devices can be provided with internal batteries for energy storage and when arranged together can thus provide cumulative energy resources. The modular frame systems are adaptable to their environment both in function and shape and can provide essential public services in co-ordination with a cloud network operating system.

The display matrix formed by arrangements of the disclosed system can be used for both advertising and informational purposes, and the shape can be adapted to the available space in the environment without disrupting displayed image data. Users can interact with the charging functions via their mobile devices through the cloud, ensuring they have access to a recharge point when they need it, and when certain types of functional module become redundant in a certain location, new functional modules can simply be swapped in to adapt to the change in needs of the environment.

Thus, according to a first aspect of the present disclosure, there is provided a modular frame system, comprising: one or more functional charging bank modules configured with a rear universal port and a front arrangement with a plurality of ports for storing and directly charging a plurality of batteries and fuel cells; one or more functional display modules configured with a rear universal port and a front screen panel spanning the entire front side of the module.

The system further comprises one or more frame devices, each frame device comprising: a housing; a universal receiving port disposed on the front of the housing for detachably coupling to a universal port of a functional module; a mounting arrangement for securing the frame device to a vertical surface; a coupling arrangement on one or more edges of the frame device configured to couple the frame device to adjacent frame devices; a power source; and a wirelessly enabled controller disposed within the housing.

Each controller of each frame device is in communication with a cloud network and is configured to: determine, via exchange of unique identifiers associated with each frame device, the number and respective positions of frame devices coupled together, and the number and type of functional modules currently installed on each frame device in that arrangement; monitor and control distribution of power to each frame device and to each coupled functional module based on the determination; and receive image data to be displayed from the cloud network and cause at least a portion of the image data to be displayed on the display screen panels of the one or more functional modules based on the determination.

In some embodiments, upon determining that two or more frame devices having display modules installed are coupled together, the controller step of causing a portion of the image data to be displayed comprises causing portions of the image data to be displayed on each display module such that, when viewed on the combined arrangement of display modules, the complete image is shown.

In some embodiments, one or more of the display modules comprise touchscreen interfaces. Users may be able to interact with the system to change one or more settings for the functional modules and communicate with the cloud network via the touchscreen interfaces.

In some embodiments, the controller is further configured to override currently displayed image data in response to notification from the cloud network of an emergency situation, and to display details of the emergency instead.

In some embodiments, one or more of the charging bank modules comprise electronically controlled locking mechanisms for holding battery devices in place within each charging port during charging.

The controller may be further configured to control the locking mechanisms based on booking data received from the cloud network.

The locking mechanisms may be magnetic locking mechanisms.

In some embodiments, the one or more charging bank modules comprise arrays of charging ports designed for charging batteries of different manufacturer specifications, including specific voltage ratings, amperage, and types of physical power outlet.

In some embodiments, the system further comprises one or more functional EV charging modules each configured with a rear universal port and a front power outlet arrangement for charging electric vehicles.

In such cases the controller may be further configured to monitor and control power distribution for the charging of any connected electric vehicles based on booking data received from the cloud network.

In some embodiments, the controller is further configured, in response to determining that one or more other frame devices are coupled to the frame device, to assign one of the frame devices as a master frame device which handles communications with the cloud network, and to cause the remaining frame devices in the coupled arrangement to assume a master/slave communications protocol with the master frame device.

In some embodiments, the power source comprises a connections to a mains power grid.

Alternatively or additionally, the power source may comprise a rechargeable battery. In embodiments with rechargeable batteries, the controller may be further configured, in response to determining that one or more other frame devices are connected to the frame device, to monitor the power usage and power levels of the batteries of the other frame devices and to supply power to them when their batteries run low.

### BRIEF DESCRIPTION OF THE DRAWINGS

Various embodiments of the invention are disclosed in the following detailed description and accompanying drawings.

FIG. 1A illustrates an isometric view of an example configuration of a functional display module that can be installed in the frame devices of the present disclosure.

FIG. 1B illustrates an isometric view of an example configuration of a functional charging bank module that can be installed in the frame devices of the present disclosure.

FIG. 1C illustrates an isometric view of an example configuration of a functional EV charging module that can be installed in the frame devices of the present disclosure.

FIG. 2A illustrates an isometric view of a display module installed on an example configuration of a frame device according to the present disclosure.

FIG. 2B illustrates the example configuration of the frame device with the exterior housing removed to show the internal structure and components.

FIG. 3A illustrates a first example arrangement of connected frame devices according to the system of the present disclosure.

FIG. 3B illustrates a second example arrangement of connected frame devices according to the system of the present disclosure.

FIG. 3C illustrates a third example arrangement of connected frame devices according to the system of the present disclosure, with a new frame device with a display module installed being added to the arrangement.

FIG. 3D illustrates the third example arrangement of FIG. 2A with the new frame device now integrated with the arrangement and displaying a portion of the image data.

FIG. 3E illustrates a fourth example arrangement of connected frame devices.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting. As used herein, the singular forms “a,” “an” and “the” are intended to include the plural forms as well, unless the context clearly indicates otherwise.

Spatially relative terms, such as “under,” “below,” “lower,” “over,” “upper” and the like, may be used herein for ease of description to describe one element or feature's relationship to another when the apparatus is right side up.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

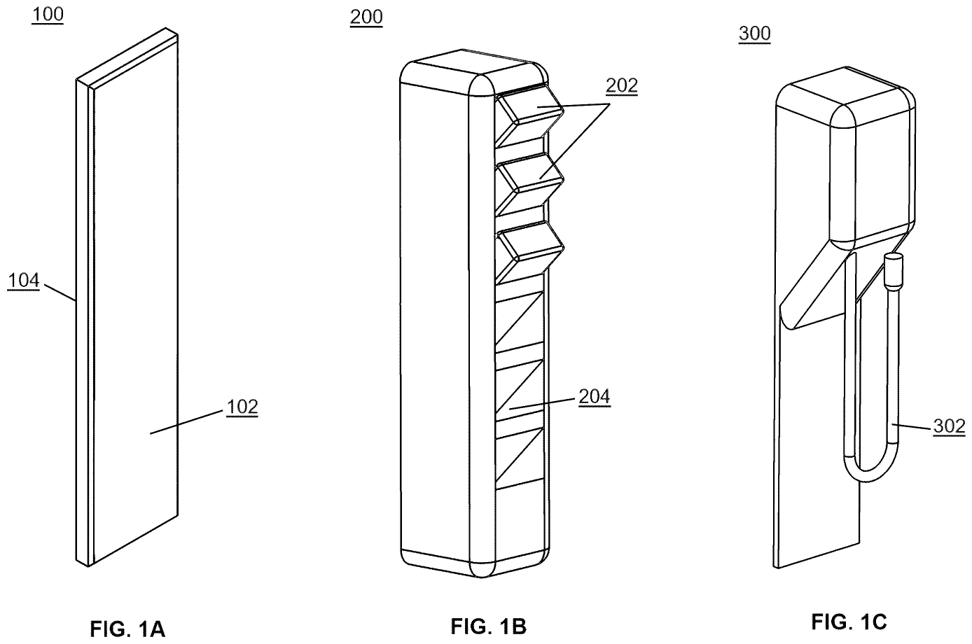

FIGS. 1A, 1B, and 1C show three different example types of functional module which can be installed in the frame devices of the disclosed modular system.

FIG. 1A shows an example display module 100 with a protective glass panel 102 covering a display 104 that spans the entirety of the front surface of the module. Thus, when adjacent frame devices with display modules 100 installed on them are connected together, the displayed form a near seamless display matrix.

FIG. 1B shows an example swappable charging bank module 200. As can be seen, the module has a number of ports 204 into which batteries and fuel cells 202 can be locked in to charge. In city environments where large numbers of publicly and privately owned light electric vehicles are being ridden which have similar batteries and fuel cells, this type of module can facilitate a system where users exchange their spent batteries for charged ones.

FIG. 1C shows an example EV charging module 300 with a power outlet 302 for directly charging an electric vehicle that is parked in front of it, this could be any type of electric vehicle including both light electric vehicles and electric automobiles.

Each of the three example modules shown will have at the rear of its housing an identical universal port that, when coupled to a frame device receiving port, will form a connection that will secure the module in place on the front of the frame device, supply it with power, and connect it to the controller of the frame device, which in turn is connected to the cloud. Users are thus able to interact with and control the operations of the various functional module types via their mobile devices.

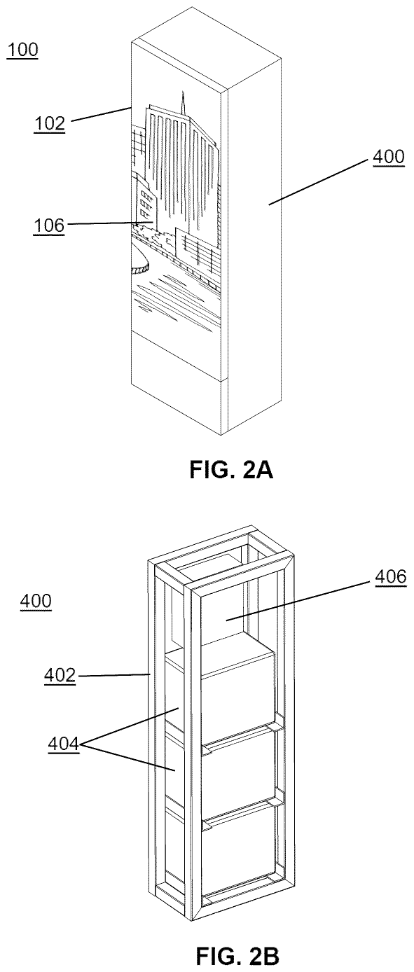

Referring to FIG. 2A and FIG. 2B, an example configuration of a frame device 400 according to the present disclosure is shown with display module 100 installed on the front (FIG. 2A) and with the exterior housing removed to show the internal frame structure 402 and components.

As can be seen, when the panel 102 of the display module 100 is installed on the frame device 400, the controller of the frame device 400 (which is housed in a control module 406) may cause it to display an image 106. This may be achieved using power directly from the grid, or using an array of internal rechargeable batteries 404 that are held inside the frame.

The controller may be configured to monitor the power levels of the batteries and recharge them from the grid when necessary—for example it may use smart charging to draw power form the grid when it is at its cheapest. Keeping the batteries charged is beneficial, as it allows the frame device to divert available power to support the functions of both functional modules that are directly installed on it, and to adjacent frame modules in an arrangement of coupled frame modules.

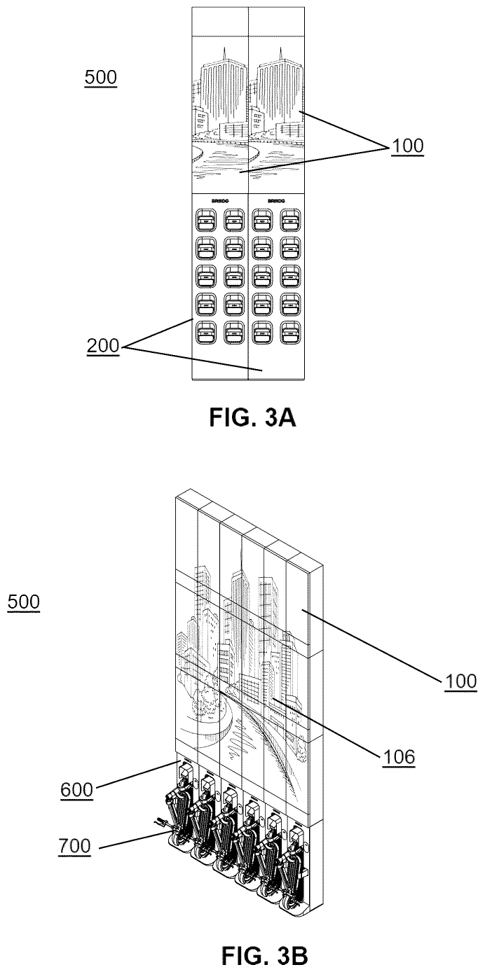

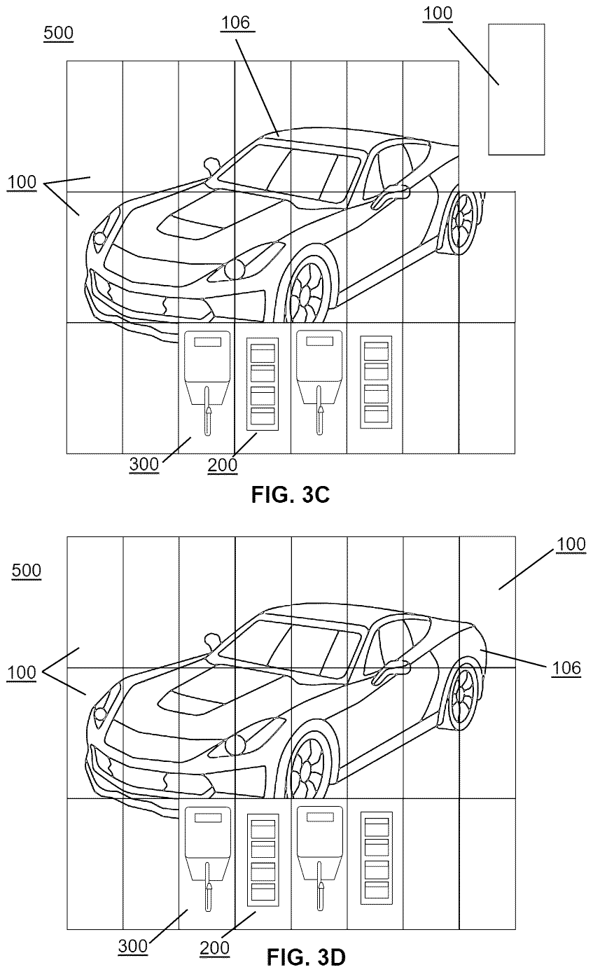

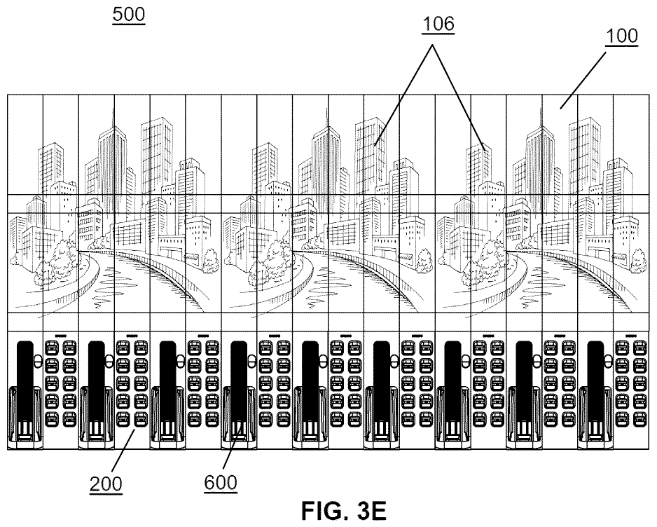

See, for example, FIG. 3A and FIG. 3B. These figures show a first and second arrangement 500 of coupled frame devices with various functional modules installed in their ports.

In FIG. 3A, a pair of swappable charge bank functional modules 200 are installed on the bottom row of the arrangement of frame devices, and a pair of display modules 100 are installed on the top row. Since the charge bank modules 200 may require a higher power output than the display modules, especially if they are charging multiple cells or batteries at once, the frame devices of the upper row may divert power from their batteries to supporting the swappable charge banks 200. This extends the battery life of the entire arrangement 500.

In FIG. 3B, a different arrangement 500 is shown where similar operations may occur, with multiple upper rows of frame devices with display modules installed on them and showing a cohesive image 106, but also being capable of sending power to the bottom row of frame devices to support the operations of a set of electric vehicle docking modules 600 that secure and charge light electric vehicles 700.

In the example of 3B the electric vehicles being docked are scooters, but as shown in FIG. 3E, docking modules 600 capable of securing and charging bicycles may also be provided.

The innovation of the disclosed system lies in its modularity, with frame devices being connectable both to one another laterally, and to any type of functional module with a universal port, allowing highly customizable arrangements that can be adapted to the needs of their environment.

FIG. 3C and FIG. 3D respectively show a frame device with a display module 100 installed on it being added to an existing display matrix arrangement 500 that has been formed by other frame devices and display modules.

As can be seen, this array of frame devices includes not only display modules, but a set of charging bank modules 200 and EV charger modules 300 on the bottom row. If more of these were needed in a given location, then other display modules 100 could be swapped out of the surrounding frame devices to make room for them, or the entire array could be extended outwards by added more frame devices to the sides (or above depending on the height and surroundings).

Furthermore, when multiple frame devices with display modules 100 installed are connected together as shown, they are configured to be able to operate together to show a single cohesive image. In the present example an advertising image of a new car model 106 is being shown.

As can be seen, the display module 100 being added to the top corner is blank until it is coupled to the arrangement, at which point it takes on the image data and shows the missing piece.

This type of display could also show information useful to the public, such as emergency alerts received via the cloud-enabled controllers of the frame devices. The displays may also operate as touchscreen panels for interacting with the system and with the cloud.

While shown in a rectangular configuration with equal numbers of frame devices in the rows and columns, the displays and frame devices could equally take on other shapes, and need not necessarily be uniform in column and row length.

The power source of the disclosed system may be a mains grid power supply, and may also involve a combination of rechargeable batteries with stored power, or even solar power and other renewable energy types.

A controller as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the modular system have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A modular frame system, comprising:
one or more functional charging bank modules configured with a rear universal port and a front arrangement with a plurality of ports for storing and directly charging a plurality of separate batteries and fuel cells of external devices;
one or more functional display modules configured with a rear universal port and a front screen panel spanning the entire front side of the module; and
one or more frame devices, each frame device comprising:
a housing;
a universal receiving port disposed on the front of the housing for detachably coupling to a universal port of a functional module;
a mounting arrangement for securing the frame device to a vertical surface;
a coupling arrangement on one or more edges of the frame device configured to couple the frame device to adjacent frame devices;
a power source; and
a wirelessly enabled controller disposed within the housing, the controller being in communication with a cloud network and configured to:
determine, via exchange of unique identifiers associated with each frame device, the number and respective positions of frame devices coupled together, and the number and type of functional modules currently installed on each frame device in that arrangement;
monitor and control distribution of power to each frame device and to each coupled functional module based on the determination; and
receive image data to be displayed from the cloud network and cause at least a portion of the image data to be displayed on the display screen panels of the one or more functional modules based on the determination, thereby forming a display matrix capable of cooperating to form a coherent image across multiple display panels if two or more functional display modules are installed in the modular frame system.

2. A modular frame system according to claim 1, wherein upon determining that two or more frame devices having display modules installed are coupled together, the controller step of causing a portion of the image data to be displayed comprises causing portions of the image data to be displayed on each display module such that, when viewed on the combined arrangement of display modules, the complete image is shown.

3. A modular frame system according to claim 1, wherein one or more of the display modules comprise touchscreen interfaces.

4. A modular frame system according to claim 3, wherein users can interact with the system to change one or more settings for the functional modules and communicate with the cloud network via the touchscreen interfaces.

5. A modular frame system according to claim 1, wherein the controller is further configured to override currently displayed image data in response to notification from the cloud network of an emergency situation, and to display details of the emergency instead.

6. A modular frame system according to claim 1, wherein one or more of the charging bank modules comprise electronically controlled locking mechanisms for holding battery devices in place within each charging port during charging.

7. A modular frame system according to claim 6, wherein the controller is further configured to control the locking mechanisms based on booking data received from the cloud network.

8. A modular frame system according to claim 6, wherein the locking mechanisms are magnetic locking mechanisms.

9. A modular frame system according to claim 1, wherein the one or more charging bank modules comprise arrays of charging ports designed for charging batteries of different manufacturer specifications, including specific voltage ratings, amperage, and types of physical power outlet.

10. A modular frame system according to claim 1, wherein the system further comprises one or more functional EV charging modules each configured with a rear universal port and a front power outlet arrangement for charging electric vehicles.

11. A modular frame system according to claim 10, wherein the controller is further configured to monitor and control power distribution for the charging of any connected electric vehicles based on booking data received from the cloud network.

12. A modular frame system according to claim 1, wherein the controller is further configured, in response to determining that one or more other frame devices are coupled to the frame device, to assign one of the frame devices as a master frame device which handles communications with the cloud network, and to cause the remaining frame devices in the coupled arrangement to assume a master/slave communications protocol with the master frame device.

13. A modular frame system according to claim 1, wherein the power source comprises a connections to a mains power grid.

14. A modular frame system according to claim 1, wherein the power source comprises one or more rechargeable batteries.

15. A modular frame system according to claim 14, wherein the controller is further configured, in response to determining that one or more other frame devices are connected to the frame device, to monitor the power usage and power levels of the batteries of the other frame devices and to supply power to them when their batteries run low.
